(19) United States
(12) Patent Application Publication
(10) Pub. No.: US 2008/0193024 A1
(43) Pub. Date: Aug. 14, 2008

(54) APPARATUS AND METHOD FOR DEBLOCK FILTERING IN A DIGITAL MOVING PICTURE PROCESSING SYSTEM

(75) Inventors: Suh-Ho Lee, Seongnam-si (KR); Joo-Kwang Kim, Yongin-si (KR); Won-Seok Heo, Hwaseong-si (KR); Jae-Hoon Jang, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 12/031,270

(22) Filed: Feb. 14, 2008

(30) Foreign Application Priority Data
Feb. 14, 2007 (KR) 15626/2007

(51) Int. Cl. G06K 9/40

(52) U.S. Cl. 382/233

(57) ABSTRACT

An apparatus deblock filters in a digital moving picture processing system with a macro block having a predetermined number of pixel blocks. An external memory controller reads a current sub-block of a current macro block from entire image data stored in an external memory, and delivers image data of an internal pixel block constituting the current sub-block and an external pixel block to a filter-dedicated memory. The filter-dedicated memory stores the delivered image data. A filtering operator performs horizontal filtering on the current sub-block using the stored image data according to a predetermined order, and performs vertical filtering on the current sub-block according to a predetermined order when the horizontal filtering is completed. The external pixel block includes pixel blocks adjacent to a top and a left side among pixel blocks adjacent to the internal pixel block.

### PRIORITY

This application claims priority under 35 U.S.C. §119(a) to a Korean Patent Application filed in the Korean Intellectual Property Office on Feb. 14, 2007 and assigned Serial No. 2007-15626, the contents of which are incorporated herein by reference.

### BACKGROUND OF THE INVENTION

1. Field of the Invention

The present invention relates generally to an apparatus and method for processing image signals in a digital moving picture processing system, and in particular, to an apparatus and method for deblock filtering in a digital moving picture processing system.

2. Description of the Related Art

1). Digital Moving Picture Processing System and H.264

The term “digital moving picture processing system” refers to a system for processing moving pictures (or moving images) using digital signals. Analog signals, when converted into digital signals, generally increase the amount of data. Especially, the amount of data of moving picture signals increases significantly after the conversion from analog signals into digital signals. Therefore, in the digital moving picture processing system, it is necessary to compress the moving picture signals. The compression is achieved by means of a video codec such as an MPEG-4 codec and an H.264 codec.

For convenience, the following description will be given herein with reference to the H.264 codec as a video codec. The H.264 codec, a video compression technology jointly proposed by the international standard organizations of the ITU-T and the ISO, noticeably decreases the bit rate necessary for implementing a same picture quality, compared to other video codecs. According to experiments, the H.264 codec has decreased the bit rate to half of the bit rate of MPEG-4 codec and to a maximum of 1/18 of the bit rate of an MPEG-2 codec. Due to its excellent performance, the H.264 codec has been adopted for the Digital Multimedia Broadcasting (DMB) and Digital Video Broadcasting-Handheld (DVB-H) standards.

2). Digital Moving Picture Signal Processing Method, Blocking Phenomenon, and Deblock Filter

A description will now be given to (1) a scheme in which digital moving picture signals are generally processed, (2) a blocking phenomenon problem caused thereby, and (3) a deblock filter provided as a solution for the problem.

(1) Definitions of Pixel, Pixel Block, and Macro Block

One image is composed of a set of multiple pixels. A pixel can be considered as a small spot or point, and a gathering of the spots forms an entire image. That is, the pixel is a minimum unit constituting an image. In order for many pixels to form an image, each pixel should have its image data. The term ‘image data’ as used herein refers to an information element of an image signal, with which a person can visually perceive the image.

The typical examples of an image data expression scheme can be classified into the RGB scheme and a YCbCr scheme based on the RGB scheme. In the well-known RGB scheme, image data is divided into three colors of Red, Green and Blue. The H.264 moving picture codec uses a YCbCr scheme, which is a new expression scheme based on the RGB scheme. Image data of the YCbCr scheme is composed of three components: a luminance component Y and two chrominance components Cb and Cr. The Cb (Chrominance b) is a blue component and the Cr (Chrominance r) is a red component.

The video codec performs a general image processing on the image data in units of predetermined sets of pixels, which are called pixel blocks. Regarding the encoding of image data, the image data is encoded in units of a predetermined number of pixel blocks. A set of such pixel blocks, in units of which the image data is encoded, is called a macro block.

For example, in the H.264 moving picture codec, a pixel block has a size of 4×4 pixels. With regard to the macro blocks, a luminance component Y has a size of 16×16 pixels (or 4×4 pixel blocks), and a chrominance component has a size of 8×8 pixels (or 2×2 pixel blocks). The reason for the different size of the macro blocks between the luminance component and the chrominance component is because there is a difference between the two components in terms of a degree at which the human eyes perceive them. That is, it is known that the human eyes are more susceptible to a change in the chrominance than a change in the luminance. Therefore, there will be little difference in the perceived picture quality if an encoding size of the luminance component is set larger and undergoes higher compression. On the other hand, in the RGB scheme, the R, G and B macro blocks are equal in size, because the colors R, G and B are equal in terms of susceptibility of human perception.

(2) Image Processing Method in H.264

A description will now be given of a method for processing image signals in a video codec in connection with the H.264 video codec.

FIGS. 1A and 1B are conceptual diagrams illustrating a method for processing image data in an H.264 video codec. Specifically, FIG. 1A illustrates an encoding scheme for a luminance component. In FIG. 1A, reference numeral 107 represents a pixel block with a 4×4 size, and C (105) shows a macro block composed of 16 pixel blocks. Also, A (101) and B (103) are macro blocks each composed of 16 pixel blocks. For simplicity, however, only the pixel blocks adjacent to C (105) are shown in A (101) and B (103). In summary, the luminance component is encoded in units of 16×16 pixels. FIG. 1B illustrates an encoding scheme for a chrominance component. Each of D (109), E (111) and F (113) represents a macro block composed of 4 pixel blocks. Therefore, the chrominance component is encoded in units of 8×8 pixels.

(3) Blocking Phenomenon and Deblock Filter

A description will now be made of a blocking phenomenon occurring in the digital moving picture processing system. Generally, digital signals are advantageous in that they are robust against noises and errors compared to the analog signals. However, when moving picture signals are processed in a digital manner, a blocking phenomenon may occur, causing degradation of the picture quality during the reproduction of the digital moving pictures. The term “blocking phenomenon” as used herein refers to a phenomenon in which during the image signal processing, as the entire image is segmented into blocks and each block is processed and encoded individually, images may be seen to be blocked in the parts adjacent to the individually processed blocks. That is, the video codec performs signal processing in units of filter blocks, and performs multi-step compression in units of macro blocks. However, the pixel blocks and/or the macro blocks are independently processed without taking into account the correlations between the blocks, which causes data loss. Currently, in order to process an arbitrary block image so as to smoothly and naturally reproduce it, the video codec tends to process the block image depending on the previous block images in the time domain and/or neighboring block images in the spatial domain. In this process, however, since the block image is processed in units of blocks, the blocking phenomenon may occur in the boundaries (or edges).

The digital moving picture processing system uses a deblock filter in order to remove the blocking phenomenon. That is, using image data of two filter blocks, the deblock filter analyzes the difference between two filter blocks to ease the difference occurring in the boundary there between, thereby contributing to the removal of the blocking phenomenon. Generally, the deblock filter performs adaptive filtering in which a filtering operation is intensively performed in the boundary area where the blocking phenomenon is significant, and the filtering operation is slightly performed in places where the blocking phenomenon is less significant.

3). Deblock Filtering Order in Conventional Digital Moving Picture Processing System

A description will now be made of an operation method of a deblock filter in the conventional digital moving picture processing system based on H.264.

FIGS. 2A and 2B are conceptual diagrams illustrating a conventional deblock filtering method in H.264. A filtering operation for one macro block is performed separately on a luminance component Y and a chrominance component CbCr of each pixel block constituting the macro block. Specifically, FIG. 2A illustrates a filtering order for a luminance component, and FIG. 2B illustrates a filtering order for a chrominance component. In FIGS. 2A and 2B, circled numerals represent the filtering order.

Referring to FIG. 2Afiltering is classified into horizontal filtering and vertical filtering. The term “horizontal filtering” refers to the filtering on the left/right boundaries of one filter block such as indicated by circled numerals 1 and 2 of FIG. 2A, and the term “vertical filtering” refers to the filtering on top/bottom boundaries of one filter block, such as indicated by circled numerals 17 and 21 of FIG. 2A. The conventional method performs vertical filterings 17 through 32 after performing horizontal filterings 1 through 16 according to the order as shown in FIG. 2A. FIG. 2B illustrates filtering on a chrominance component. Because a macro block used for encoding a chrominance component has a size of 8×8 pixels, the conventional method performs 8 filtering operations. That is, the filtering operations are performed in order of the horizontal filterings 1 through 4 and the vertical filterings 5 through 8.

4). Conventional Memory Structure Used According to Deblocking Order

FIGS. 3A and 3B are diagrams illustrating conventional memory structures needed according to a filtering order for one macro block. Specifically, FIG. 3A illustrates a memory structure for filtering a luminance component, and FIG. 3B illustrates a memory structure for filtering a chrominance component. Reference numeral 301 indicates a memory block for vertical filtering, and reference numeral 303 indicates a memory block for horizontal filtering. It can be seen that both memory blocks are equal in the number of filter blocks necessary for their filterings.

Therefore, because, in FIG. 2A, image data composed of a total of 20 filter blocks, including 16 filter blocks of the current macro block and 4 filter blocks adjacent to the top, is needed for vertical filtering, the memory block should also has the same structure. Similarly, in the memory block 303 for horizontal filtering, one memory block has a size of 16×4 bits. Therefore, both the memory block 303 for horizontal filtering and the memory block 301 for vertical filtering have a size of 80×32 bits.

FIG. 3B illustrates a memory structure for filtering a chrominance component. Reference numeral 305 indicates a memory structure for vertical filtering of the chrominance component, and reference numeral 307 indicates a memory structure for horizontal filtering of the chrominance component. For a description thereof, reference can be made to FIG. 3A.

5). Problems of Conventional Deblocking Memory Structure

As described above, because the operation method of the conventional deblock filter performs vertical filtering after fully performing horizontal filtering on one macro block, the memory should also have the same structure as that of the filter block necessary for filtering on the macro block. Accordingly, there is a need for a memory of a deblock filter and its hardware structure that optimize the filtering operation by minimizing the use of the memory.

### SUMMARY OF THE INVENTION

An aspect of the present invention is to address at least the problems and/or disadvantages mentioned above and to provide at least the advantages described below. Accordingly, an aspect of the present invention is to provide a deblock filter capable of reducing hardware complexity in a system for processing image signals and a filtering method based thereon.

Another aspect of the present invention is to provide a deblock filter for optimizing a filtering operation while minimizing the use of a memory in a system for processing image signals and a filtering method based thereon.

According to one aspect of the present invention, there is provided an apparatus for deblock filtering in a digital moving picture processing system with a macro block having a predetermined number of pixel blocks. The apparatus includes an external memory controller for reading a current sub-block of a current macro block from entire image data stored in an external memory, and delivering image data of an internal pixel block constituting the current sub-block and an external pixel block, to a filter-dedicated memory; the filter-dedicated memory for storing the delivered image data; and a filtering operator for performing horizontal filtering on the current sub-block using the stored image data according to a predetermined order, and performing vertical filtering on the current sub-block according to a predetermined order when the horizontal filtering is completed. The external pixel block includes pixel blocks adjacent to the top and the left sides among pixel blocks adjacent to the internal pixel block.

According to another aspect of the present invention, there is provided a method for deblock filtering in a digital moving picture processing system with a macro block having a predetermined number of pixel blocks. The method includes determining a current filtering-target sub-block among sub-blocks of a current macro block; storing, in a memory, image data of an internal pixel block and an external pixel block of the determined current sub-block; performing horizontal filtering on the current sub-block using the stored image data according to a predetermined order; and performing vertical filtering on the current sub-block according to a predetermined order, when the horizontal filtering is completed. The external pixel block includes pixel blocks adjacent to the top and the left sides among pixel blocks adjacent to the internal pixel block.

### BRIEF DESCRIPTION OF THE DRAWINGS

The above and other aspects, features and advantages of the present invention will become more apparent from the following detailed description when taken in conjunction with the accompanying drawings in which:

FIGS. 1A and 1B are conceptual diagrams illustrating a method for processing image data in an H.264 video codec;

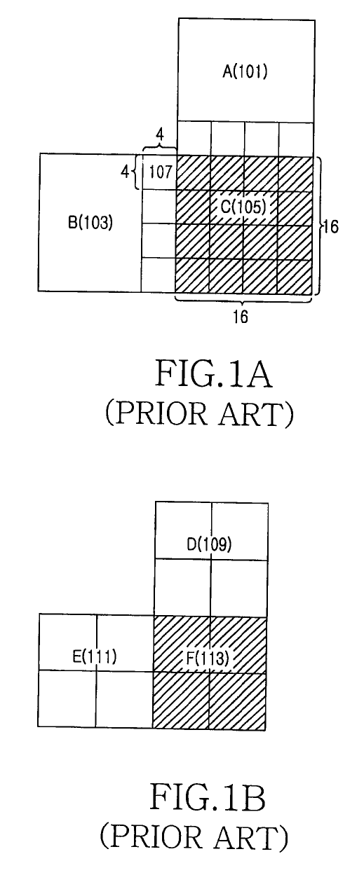

FIGS. 2A and 2B are conceptual diagrams illustrating a conventional deblock filtering method in H.264;

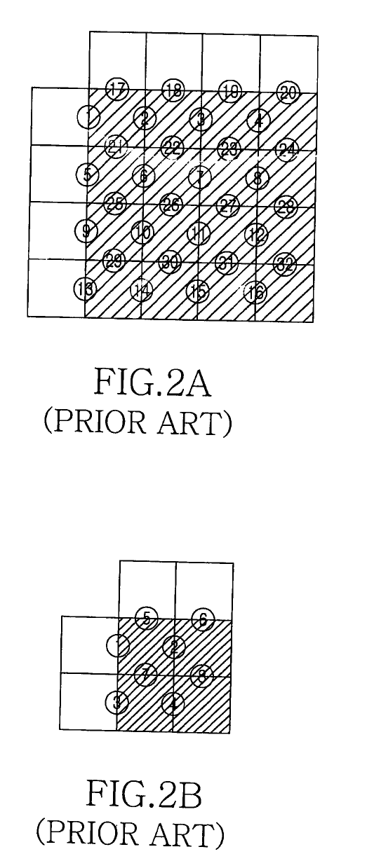

FIGS. 3A and 3B are diagrams illustrating conventional memory structures needed according to a filtering order for one macro block;

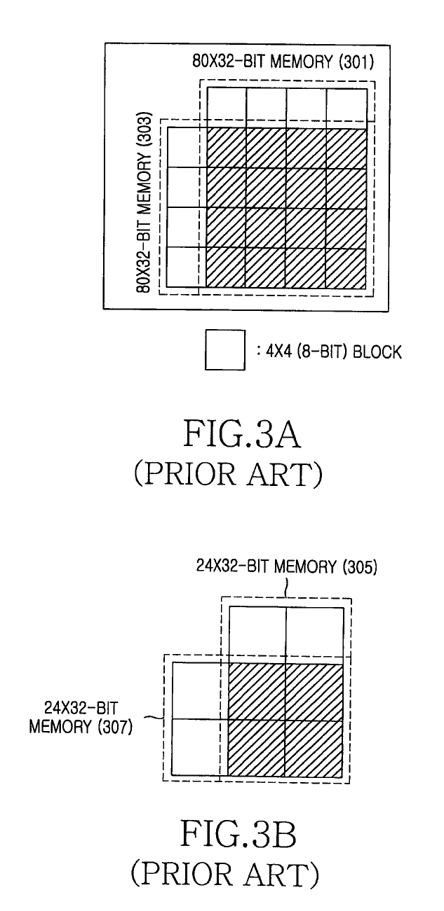

FIGS. 4A and 4B are conceptual diagrams illustrating a filtering order for boundaries in one macro block according to an embodiment of the present invention;

FIGS. 5A and 5B diagrams illustrating structures of a memory used for a filtering method according to an embodiment of the present invention;

FIG. 6 is a block diagram illustrating a deblock filter according to an embodiment of the present invention; and

FIG. 7 is a flowchart illustrating a deblock filtering method according to an embodiment of the present invention.

### DETAILED DESCRIPTION OF THE PREFERRED EMBODIMENTS

Preferred embodiments of the present invention will now be described in detail with reference to the annexed drawings. In the drawings, the same or similar elements are denoted by the same reference numerals even though they may be depicted in different drawings. The matters defined in the description such as a detailed construction and elements are provided to assist in a comprehensive understanding of the exemplary embodiments of the invention. In the following description, a detailed description of known functions and configurations incorporated herein has been omitted for clarity and conciseness.

The present invention provides a deblock filter for optimizing a filtering operation while reducing hardware complexity in a system for processing image signals, and a filtering method based thereon. To this end, a description will first be made of a filtering order proposed by the present invention, and then a description will be given of a deblock filter for implementing the filtering order according to the present invention. Although the following description will be made herein with reference to an H.264 video codec, it should be noted that the same can be applied to any codec that processes an image in units of pixel blocks and encodes the image in units of macro blocks.

1. Filtering Order of Present Invention

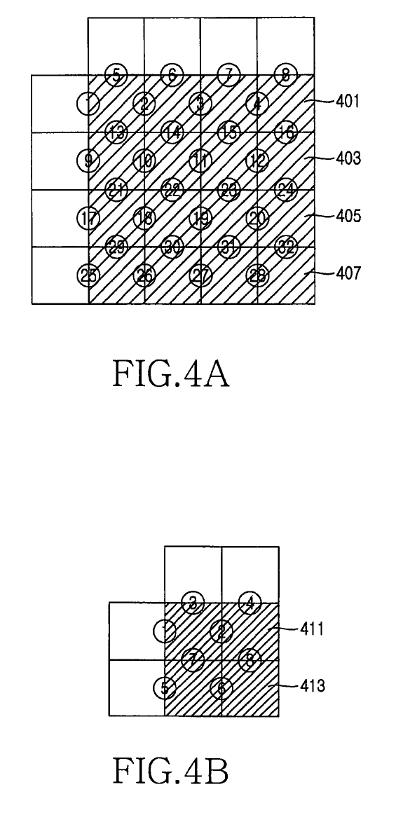

FIGS. 4A and 4B are conceptual diagrams illustrating a filtering order for boundaries in one macro block according to an embodiment of the present invention. Specifically, FIG. 4A illustrates a filtering order for a luminance component, and FIG. 4B illustrates a filtering order for a chrominance component. A filtering operation for one macro block is performed independently on a luminance component Y and a chrominance component CbCr of pixel blocks constituting the macro block. For reference, in the boundary where a macro block of a luminance component and a macro block of a chrominance component overlap, only the filter coefficients are shared, thus increasing the filtering efficiency. The filtering order proposed by the present invention is as shown in FIG. 4A, and a detailed description thereof will be given below.

A basic principle of the filtering order proposed by the present invention is as follows.

(1) Sub-Block Based Filtering

“Sub-block” is a term disclosed by the present invention. The sub-block is a sum of a predetermined number of filter blocks. For example, in FIG. 4A, reference numeral 401 represents a sub-block of 4 pixel blocks, and reference numerals 403, 405 and 407 also represent sub-blocks of the same structure. That is, the sub-block has a size of 1×4 pixel blocks. Generally, the number of pixel blocks in the vertical column of the sub-block is 1, and the number of pixel blocks in the horizontal row of a macro block is the number (4 in the above example) of pixel blocks constituting the macro block. According to an alternative system design, the number of pixel blocks in the vertical column can be a plural number. That is, the number of pixel blocks constituting the vertical column of the sub-block is subject to change.

(2) Filtering Performed in Order of Sub-Blocks Closer to Adjacent Macro Block

This is used for determining a filtering order among sub-blocks. That is, the sub-block 401 first undergoes filtering, because the sub-block 401, compared to the other sub-blocks 403, 405 and 407, is closer to the macro block adjacent to the top.

Once the sub-block which will be filtered (“filtering-target sub-block”) is selected, this principle can also be used for determining which filter block will be filtered. That is, for horizontal filtering on the sub-block 401, the pixel block adjacent to the left macro block should be filtered first. Therefore, the pixel blocks undergo horizontal filtering in order of circled numerals 1, 2, 3 and 4. For vertical filtering, because the filter blocks of the sub-block 401 are all adjacent to the top macro block, the vertical filtering order can be arbitrary. In FIG. 4, they are marked with circled numerals 5, 6, 7 and 8 for referencing convenience. That is, for vertical filtering, it doesn't matter which pixel block first undergoes filtering.

The reason that the sub-blocks undergo filtering in order of the sub-blocks closer to the external macro block is as follows. Generally, the blocking phenomenon caused by encoding between macro blocks is more significant than the inter-filter block blocking phenomenon occurring in one macro block. Therefore, the part where the blocking phenomenon is most significant first undergoes the filtering operation, thereby facilitating efficient filtering. For example, it can be provided that only the filter blocks where the blocking phenomenon is more significant undergo filtering and the filter blocks where the blocking phenomenon is less significant do not undergo filtering, thereby contributing to an increase in the filtering rate.

(3) Exemplary Filtering Based on Filtering Order

According to the filtering order determination method defined in (1) and (2) above, filtering on the sub-block 401 is first conducted as shown in FIG. 4A. For the filtering order in the sub-block 401, the part with circled numeral 1 first undergoes horizontal filtering according to the foregoing principle. Although there is no restriction on the vertical filtering order, it is provided herein that the part with circled numeral 5 first undergoes vertical filtering for convenience, which is similar to the horizontal filtering order. Filtering on the chrominance component shown in FIG. 4B is also performed in the same manner.

According to the foregoing filtering scheme, while the conventional method performs vertical filtering after completing horizontal filtering on all filter blocks, the present invention performs horizontal filtering and vertical filtering on one sub-block. In the present invention, since filtering on one sub-block is first completed, it is possible to clear the information necessary for the completed sub-block filtering and then store information necessary for the next sub-block filtering in a memory.

2. Memory Structure Applied for Filtering

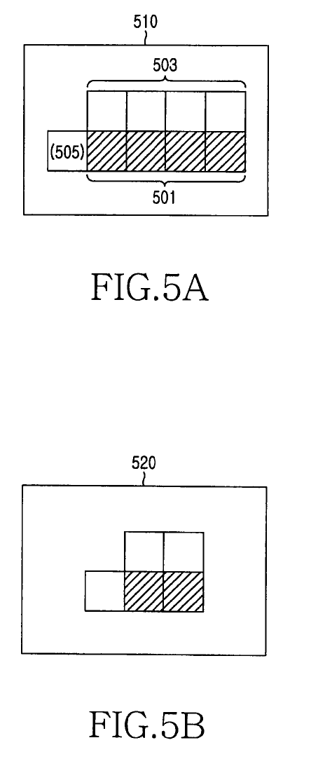

FIGS. 5A and 5B illustrate the structures of a memory used for a filtering method according to the present invention.

(1) Memory Structure

As described above, the present invention performs horizontal/vertical filterings in units of sub-blocks with a size of 1×4 pixel blocks. Therefore, unlike the conventional memory structure, the new memory structure can be designed to store the image data of a sub-block and the image data of a pixel block adjacent thereto.

A memory 500 used in the present invention is composed of an internal memory block 501, and external memory blocks 503 and 505. Image data of internal pixel blocks is stored in the internal memory block 501, and image data of external pixel blocks is stored in the external memory blocks 503 and 505. The term “internal pixel blocks” refers to pixel blocks belonging to the current filtering-target sub-block, and the term “external pixel blocks” refers to pixel blocks located in a specific direction(s) among the pixel blocks adjacent to the internal pixel blocks. That is, for the pixel blocks adjacent to the internal pixel blocks, although a total of 10 pixel blocks are adjacent to each other in the top/bottom/left/right directions, only the pixel blocks located in the top and the left sides are considered external pixel blocks herein for the following reason. That is, because top and bottom are relative positions that if the entire image data undergoes filtering during filtering on one sub-block, duplicate filtering occurs during filtering on the next sub-block, thus causing waste. Similarly, only the left-side pixel block among the left/right-side pixel blocks is used for the same reason.

Therefore, it can be seen in FIG. 5B that the internal memory block 501 is composed of 4 memory modules, and the external memory blocks 503 and 505 are composed of 5 memory blocks. In addition, the external memory blocks 503 and 505 include a first external memory block 503 composed of 4 memory blocks adjacent to the top of the internal pixel blocks, and a second external memory block 505 composed of 1 memory module adjacent to the left side.

(2) Memory Size

In the H.264 video codec, since one pixel block has 4×4 pixels and one pixel has 8 bits, the internal memory block is (4×8)×(4×4)=32×16 bits, and the external memory block is (4×8)×(4×5)=32×20 bits. Therefore, the required memory is a total of (32×36) bits.

The internal memory block 501 and the first external memory block 503 are used for a vertical filtering operation, and the internal memory block 501 and the second external memory block 505 are used for a horizontal filtering operation. Because the present invention performs horizontal/vertical filterings in units of sub-blocks, it only needs a memory for storing image data of pixel blocks of the current sub-block and pixel blocks adjacent thereto.

(3) Detailed Application

To apply the filtering order provided by the present invention, the H.264 video codec stores image data of pixel blocks of the sub-block 401 in the internal memory block 501 for a filtering operation of the sub-block 401 of FIG. 4. In addition, image data of pixel blocks adjacent to the top of the sub-block is stored in the first external memory block 503, and image data of a pixel block adjacent to the left side is stored in the second external memory block 505. Thereafter, the H.264 video codec performs a horizontal filtering operation using the information stored in the internal memory block 501 and the second external memory block 505, and performs a vertical filtering operation using the image data stored in the internal memory block 501 and the first external memory block 503.

If the full filtering operation of the sub-block 401 is completed, the H.264 video codec clears the image data stored in the memory 500, and repeats the same process on the next sub-block 403. This process is repeated until filtering on the last sub-block 407 is completed.

(4) Filtering on Chrominance Component

While a description of the filtering method for the luminance component has been given with reference to FIG. 5A, filtering on a chrominance component can be performed using a chrominance component memory 520 of FIG. 5B separately. Since the chrominance component is composed of two chroma components Cb and Cr, two chrominance component memories 520 will be provided and used for Cb and Cr filterings respectively. For a description of its detailed application, reference can be made to FIG. 5A.

In some cases, however, the H.264 video codec can perform filtering on the chrominance component using the luminance component memory 500 of FIG. 5A. That is, since a macro block of the chrominance component is less in size than a macro block of the luminance component, it is obvious that filtering on the chrominance component can be performed with the memory 500 for the luminance component. However, the filtering on the chrominance component performed with the luminance component memory 500 will be greater in the required time than the filtering performed with the memory 520 separately provided for the chrominance component. Therefore, while a system requiring a fast filtering operation will separately provide the luminance component memory 500 and the chrominance component memory 520, a system not requiring the fast filtering operation can perform filtering on the chrominance component using the luminance component memory 500.

3. Filtering Apparatus

A description will now be made of a filtering apparatus to which the filtering order and memory structure of the present invention are applied.

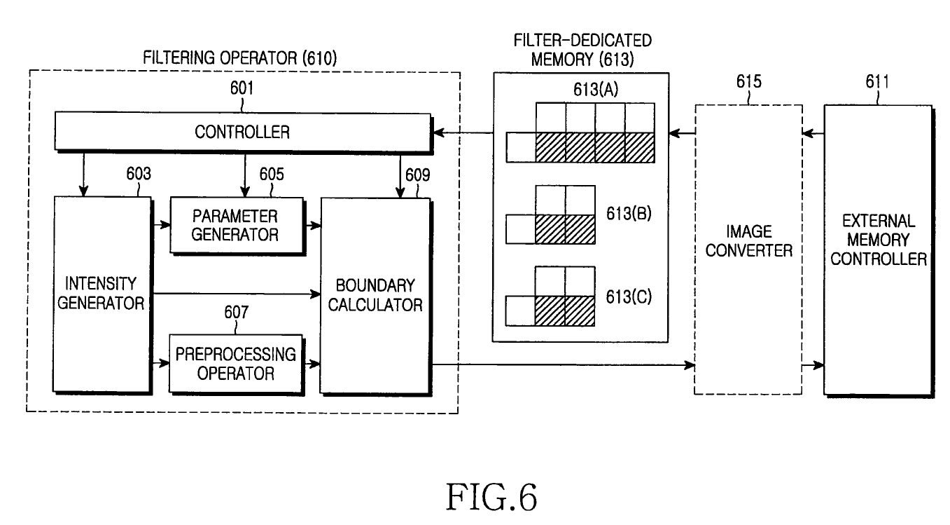

FIG. 6 is a block diagram illustrating a deblock filter according to an embodiment of the present invention. A deblock filter 600 according to the present invention includes a filtering operator 610, an external memory controller 611, and a filter-dedicated memory 613. In addition, the deblock filter 600 can include an image converter 615.

The filtering operator 610 performs a horizontal-vertical 2-dimensional filtering operation on the provided image data stored in the filter-dedicated memory 613. In this case, the filtering operation is performed in units of sub-blocks as described above. The filtering operator 610 includes a controller 601, an intensity generator 603, a parameter generator 605, a preprocessing operator 607, and a boundary calculator 609.

The controller 601 is a block for determining a filtering order for sub-blocks constituting a macro block and a filtering order for filter blocks constituting a sub-block, and performing the overall control on the data transmission and data storage.

The intensity generator 603 adjusts filtering intensity according to the encoding method for quantization parameters and adjacent blocks, and the variation rate of image samples adjacent to the filter blocks. The intensity generator 603 can either perform or not perform filtering on the corresponding filter blocks according to the generated filtering intensity. For example, it is general to perform filtering on the pixel blocks adjacent to the external macro block at a high filtering intensity. However, for the filtering performed between pixel blocks in the current macro block, as the blocking phenomenon occur less often, it is possible to perform no filtering or perform the filtering at a low filtering intensity. Whether to perform the filtering can be set depending on the previous setting.

The parameter generator 605 generates several parameters to be used for performing filtering. The preprocessing operator 607 is an operator added to avoid duplicate execution of the filtering operation. Most of the filtering operations are expressed as addition and shift calculations.

The boundary calculator 609 calculates horizontal/vertical boundaries of a corresponding pixel block using the result values output from the intensity generator 603, the parameter generator 605 and the preprocessing operator 607, and generates a filtering result value. The generated filtering result value is stored in the filter-dedicated memory 613, and can also be finally stored in the external memory (not shown) by means of the external memory controller 611 so that the filtered image can be displayed for a user.

The external memory controller 611 delivers the image data to the filter-dedicated memory 613 in units of sub-blocks. That is, the external memory controller 611 reads sub-block based image data and image data of adjacent pixel blocks from the external memory (not shown) where the entire image is stored, and delivers the read image data to the filter-dedicated memory 613. When the filtering operation of the sub-block is completed, the external memory controller 611 reads the next sub-block. Although generally that selection of sub-blocks based on the filtering order is performed herein by the controller 601 as described above, in some cases, the external memory controller 611 can directly perform the sub-block selection. In this case, the controller 601 will serve to determine a filtering order for filter blocks constituting the selected sub-block.

The filter-dedicated memory 613 includes memory blocks based on the above-described memory structures. That is, for the YCbCr scheme, the filter-dedicated memory 613 includes a luminance component memory 613a and chrominance component memories 613b and 613c. In some cases, as described above, the filter-dedicated memory 613 can perform filtering on the chrominance component only with the luminance component memory 613a.

In the case where the image stored in the external memory uses the RGB scheme, there is a further need for the image converter 615. That is, the image converter 615 serves to convert the RGB scheme into the YCbCr scheme.

4. Filtering Method

A description will now be made of a deblock filtering method according to the present invention.

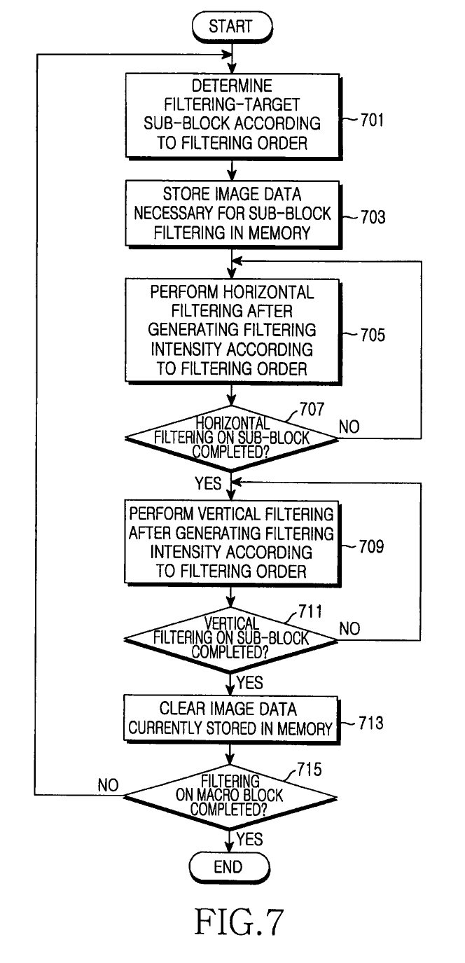

FIG. 7 is a flowchart illustrating a deblock filtering method according to an embodiment of the present invention. In step 701, the deblock filtering method determines a filtering-target sub-block according to a filtering order. That is, the deblock filtering method will select a sub-block in order of the sub-block most adjacent to the external macro block according to the foregoing filtering order. Although the selection is generally performed by a controller 601, in some cases, it can also be performed by an external memory controller 611. In step 703, the deblock filtering method stores image data necessary for filtering on the selected sub-block in a memory. That is, the deblock filtering method reads image data of pixel blocks of the sub-block and pixel blocks adjacent thereto, and stores the read image data in a filter-dedicated memory 613. In step 705, the deblock filtering method performs horizontal filtering on the image data according to the filtering order.

In step 707, the deblock filtering method determines whether the horizontal filtering on the sub-block is completed. If the horizontal filtering is not completed, the deblock filtering method returns to step 705, and if completed, proceeds to step 709. In step 709, the deblock filtering method performs vertical filtering on the sub-block according to the filtering order. In step 711, the deblock filtering method determines whether the vertical filtering on the sub-block is completed. If the vertical filtering is not completed, the deblock filtering method returns to step 709, and if completed, proceeds to step 713. In step 713, the deblock filtering method clears all the image data currently stored in the memory, because both the horizontal and vertical filterings have been completed on the current sub-block. In step 715, the deblock filtering method determines whether filtering on the current macro block has been completed. If the filtering is not completed, the deblock filtering method returns to step 701 and repeats filtering on the next sub-block. If the filtering is completed, the deblock filtering method comes to an end.

5. Exemplary Modification

A description has been made of the present invention that performs vertical filtering after completing horizontal filtering on a sub-block. However, an alternative system can perform horizontal filtering after completing vertical filtering. Further, in some cases, the system can perform filtering in units of one pixel block. That is, an alternative system can determine a filtering-target pixel block in a macro block according to a filtering order of the present invention, and perform filtering on the next pixel block after completing horizontal filtering and vertical filtering in units of pixel blocks, thereby contributing to minimization in the required memory size. However, due to the excessively subdivided filtering, the system may suffer from wastes, but may be advantageous under different system conditions.

6. Quantitative Comparison with Conventional Memory Structure

Because the deblock filter of the present invention performs the filtering operation in units of sub-blocks, its reduction in the amount of data calculated in each filtering step simplifies a data flow and facilitates simple memory use, thereby contributing to a reduction in the time required for filtering. In addition, the use of a smaller-sized memory contributes to a decrease in the hardware complexity. While the conventional memory has a size of 80×32 bits (horizontal) +80×32 bits (vertical)=160×32 bits, the new memory proposed by the present invention has a size of 16×32 bits+20×32 bits=36×32 bits. As a result, it can be appreciated that the memory size of the present invention reduces (36/160)*100=77.5% from the conventional memory size.

As is apparent from the foregoing description, the deblock filter apparatus and method according to the present invention performs the filtering operation in units of sub-blocks, so the image can be displayed for the user without being delayed by the filtering operation. In addition, the present invention minimizes the memory size required for filtering, thus contributing to a decrease in the hardware complexity. Further, the present invention can be configured to adapt the image having a different image expression scheme with the same hardware, thus increasing the hardware compatibility.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for deblock filtering in a digital moving picture processing system with a macro block having a predetermined number of pixel blocks, the method comprising:
determining a current filtering-target sub-block among sub-blocks of a current macro block;
storing, in a memory, image data of an internal pixel block and an external pixel block of the determined current sub-block;
performing horizontal filtering on the current sub-block using the stored image data according to a predetermined order; and
performing vertical filtering on the current sub-block according to a predetermined order, when the horizontal filtering is completed,
wherein the external pixel block includes pixel blocks adjacent to a top and a left side among pixel blocks adjacent to the internal pixel block.

2. The method of claim 1, wherein determining a current sub-block comprises:
selecting a sub-block closest to an external macro block located in a top of the current macro block among the sub-blocks that have not undergone deblock filtering.

3. The method of claim 1, wherein storing image data in a memory comprises:
storing the image data in a filter-dedicated memory having a structure corresponding to the internal pixel block and the external pixel block.

4. The method of claim 1, wherein performing horizontal filtering comprises:
selecting an internal pixel block among the internal pixel blocks in an order of an internal pixel block closer to an external pixel block located in a left side of the current sub-block, and performing horizontal filtering on each of the selected internal pixel block.

5. The method of claim 4, wherein performing horizontal filtering comprises:
generating a filtering intensity for the selected internal pixel block, and performing horizontal filtering on each of the selected internal pixel block depending on the generated filtering intensity.

6. The method of claim 5, wherein performing vertical filtering comprises:
selecting an internal pixel block according to an order for the horizontal filtering, and performing vertical filtering on each of the selected internal pixel block.

7. The method of claim 6, wherein performing vertical filtering comprises:
generating a filtering intensity for the selected internal pixel block, and performing vertical filtering on each of the selected internal pixel block depending on the generated filtering intensity.

8. The method of claim 1, further comprising:
after performing the vertical filtering, clearing image data stored in the filter-dedicated memory.

9. The method of claim 1, wherein the digital moving picture processing system uses a YCbCr scheme.

10. The method of claim 1, wherein storing image data in a memory comprises:
when the digital moving picture processing system uses an RGB scheme, converting the RGB scheme into a YCbCr scheme, and storing the YCbCr scheme in the memory.

11. An apparatus for deblock filtering in a digital moving picture processing system with a macro block having a predetermined number of pixel blocks, the apparatus comprising:
an external memory controller for reading a current sub-block of a current macro block from entire image data stored in an external memory, and delivering image data of an internal pixel block constituting the current sub-block and an external pixel block, to a filter-dedicated memory;
the filter-dedicated memory for storing the delivered image data; and
a filtering operator for performing horizontal filtering on the current sub-block using the stored image data according to a predetermined order, and performing vertical filtering on the current sub-block according to a predetermined order when the horizontal filtering is completed,
wherein the external pixel block includes pixel blocks adjacent to a top and a left side among pixel blocks adjacent to the internal pixel block.

12. The apparatus of claim 11, wherein the filtering operator includes a controller for determining, as a current sub-block, a sub-block closest to an external macro block located in a top of the current macro block.

13. The apparatus of claim 11, wherein the filter-dedicated memory has a structure corresponding to the internal pixel block and the external pixel block.

14. The apparatus of claim 11, wherein the controller is adapted to receive the image data from the filter-dedicated memory and determine a horizontal filtering order using the image data in a way of selecting an internal pixel block among the internal pixel blocks in an order of an internal pixel block closer to an external pixel block located in a left side of the sub-block,
wherein the filtering operator further comprises a boundary calculator for performing a horizontal filtering operation on the sub-block depending on the image data and the determined horizontal filtering order provided from the controller.

15. The apparatus of claim 14, wherein the filtering operator further comprises a filtering intensity generator for generating a horizontal filtering intensity for each internal filter block scheduled to undergo horizontal filtering depending on the image data and the horizontal filtering order provided from the controller,
wherein the boundary calculator is adapted to perform a filtering operation on each of the internal filter block depending on the generated horizontal filtering intensity.

16. The apparatus of claim 15, wherein the controller is adapted to determine a vertical filtering order according to an order for the horizontal filtering,
wherein the boundary calculator is adapted to perform vertical filtering on each of the internal filter block depending on the vertical filtering order provided from the controller.

17. The apparatus of claim 16, wherein the intensity generator is adapted to generate a vertical filtering intensity separately for each internal filter block scheduled to undergo vertical filtering depending on the vertical filtering order provided from the controller,
wherein the boundary calculator is adapted to perform a vertical filtering operation on each of the internal filter block depending on the generated vertical filtering intensity.

18. The apparatus of claim 11, wherein the external memory controller clears the image data stored in the filter-dedicated memory after the horizontal and vertical filtering on the current sub-block is completed.

19. The apparatus of claim 11, wherein the digital moving picture processing system uses a YCbCr scheme.

20. The apparatus of claim 11, further comprising:
a image converter for converting an image expression scheme of the image data provided from the external memory controller into a YCbCr scheme and delivering the converted image data to the filter-dedicated memory, when the digital moving picture processing system uses an RGB scheme.

21. The apparatus of claim 19, wherein the filter-dedicated memory includes a memory corresponding to each image element constituting an image expression scheme of the digital moving picture processing system.

22. The apparatus of claim 11, wherein the filter-dedicated memory includes a memory corresponding to an image element having a maximum memory size, among image elements constituting an image expression scheme of the digital moving picture processing system.
